(19) United States
(12) Patent Application Publication
(10) Pub. No.: US 2006/0084000 A1
(43) Pub. Date: Apr. 20, 2006

(54) Toner composition for electrophotographic imaging apparatus and method of preparing the same

(75) Inventors: Koichi Tsunemi, Suwon-si (KR); Jun-ho Kim, Suwon-si (KR); Yong-baek Yoo, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/210,906

(22) Filed: Aug. 25, 2005

(30) Foreign Application Priority Data
Oct. 18, 2004 (KR) 2004-83215

(51) Int. Cl. G03G 9/09

(52) U.S. Cl. 430/108.4; 430/108.6; 430/108.7; 430/108.8

(57) ABSTRACT

A toner composition and a method of preparing the same provide a toner composition that includes a coloring agent, a charge control agent, a binder, a wax and an internal additive, wherein the coloring agent and wax are contained as a master batch, and the internal additive includes toner particles having at least one component selected from a hydrophobic silica, a hydrophobic titanium oxide and/or a hydrophobic aluminain e.g., an electrophotographic imaging apparatus. A toner composition has an enhanced pulverizing property obtained by preparing the toner composition by a pulverizing method, wherein charges are readily controlled, the durability of the final toner composition is significant, and the images have an improved quality, permitting printing of a significant number of copies thereof,

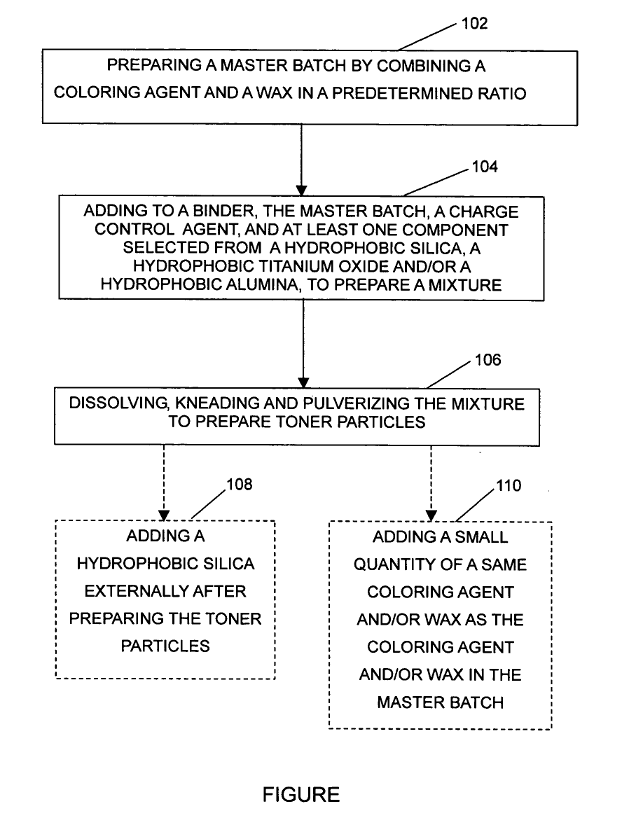

### CROSS-REFERENCE TO RELATED APPLICATIONS

This application claims benefit under 35 U.S.C. § 119 from Korean Patent Application No. 2004-83215, filed on Oct. 18, 2004, the entire content of which is incorporated herein by reference.

### BACKGROUND OF THE INVENTION

1. Field of the Invention

The present invention relates to a toner composition for an electrophotographic imaging apparatus and a method of preparing the same. More particularly, the present invention relates to a toner composition in which durability and stability are improved by including a coloring agent and a wax by a master batch method, and by which multiple copies of a clear image with high quality may be stably printed out.

2. Description of the Related Art

Recently, an electrophotographic imaging apparatus including a laser printer, a facsimile, a copying machine, and the like, through which the high quality of an image may be obtained in high speed, is generally used. Such an electrophotographic imaging apparatus may be divided into dry-type and wet-type, depending on a developer to be used. The present invention relates to a toner composition that is the dry-type.

The dry-type toner is generally formed by including a coloring agent, a binder, a charge control agent and a releasing agent, and by further including an additive, depending on a function required in a toner. The additives are divided into an internal additive that is added to the inside of toner particles and an external additive that is added to the outside of toner particles. A toner is a particulate having a size of a few μm that forms a printed image on a recording medium. To achieve the rapid electrophotography, the high quality of an image and the minimum environmental contamination, the micronization of particles and the improvement in dispersity of a coloring agent or a releasing agent, or the like, are needed.

Generally, the method of preparing a toner includes a polymerization method and a pulverizing method. The pulverizing method includes mixing a coloring agent, a binder, a charge control agent, or the like, kneading, pulverizing and classifying. Then, an additive is added externally, thus forming a toner composition.

A toner composition prepared by the pulverizing method is known to contain excessive releasing agent components in fine powders of prepulverized toner particles. When the toner is cured to form a small grain, the fine powders of prepulverized toner are generated in great quantities. Thus, the properties of the material to be expected for a toner composition cannot be sufficiently obtained. Accordingly, the development of a toner, which is cured to form a small grain, while suppressing the generation of fine powders and maintaining the properties of the material to be needed for a toner is desired.

A releasing agent is generally added to toner particles in a toner composition as an internal additive. The releasing agent prevents the toner offset by improving release properties between a roller and a toner when a toner image is transferred to a recording medium and fused thereon, and prevents the recording medium from sticking to the roller thus becoming entangled therewith.

The material generally used as a releasing agent is a wax. Since the wax that is not compatible with a binder is usually used, the wax is dispersed in the binder by applying high shear force when it is dissolved in the binder, and then kneaded. However, to increase the contents of the wax in the binder, a relatively high shear force is needed. When such a high shear force is applied, the molecular chain used as a binding agent is cleaved, thus decreasing the molecular weight. Accordingly, a master batch is utilized by highly dispersing, instead of applying a high shear force. However, due to the cost of processing, only a master batch prepared by mixing a coloring agent and a binder has been developed. Thus, the method of highly dispersing a wax without such problems is required.

Furthermore, from only highly dispersing a wax, the stability of a charge or the stability of an imaging apparatus being utilized cannot be obtained, and an image defect, such as lack of clarity, may occur when relatively substantial quantities of copies are printed out.

### SUMMARY OF THE INVENTION

Accordingly, it is an aspect of the present invention to provide a toner composition which provides an image with high resolution, has highly dispersed coloring agent and wax, exhibits suppressed generation of fine powders, and thus, maintains the properties of the material for a toner composition are maintained, and the method of preparing the same.

The above aspect of the present invention is substantially realized by providing a toner composition which includes a coloring agent, a charge control agent, a binder, a wax and an internal additive, wherein the coloring agent and wax are combined as a master batch, and the internal additive includes toner particles i having at least one component selected from the group consisting of a hydrophobic silica, a hydrophobic titanium oxide and a hydrophobic alumina.

The quantity of the coloring agent is generally about 1% to about 8% by weight, based on 100% by weight of the total toner particles.

The quantity of the charge control agent is typically about 0.1% to about 6% by weight, based on 100% by weight of the total toner particles.

The quantity of the binder is generally about 80% to about 98% by weight, based on 100% by weight of the total toner particles.

The quantity of the wax is typically about 0.5% to about 10% by weight, based on 100% by weight of the total toner particles.

The quantity of at least one hydrophobic silica, hydrophobic titanium oxide and/or a hydrophobic alumina is generally about 0.05% to about 3% by weight, based on 100% by weight of the total toner particles.

The master batch is prepared such that the ratio of the coloring agent to the wax is about 1:9 to 9:1.

The toner composition may further comprise an external additive, such as a hydrophobic silica.

The hydrophobic silica utilized as the internal additive may be the same type as the hydrophobic silica utilized as the external additive.

The coloring agent is further utilized with the toner particles in addition to the coloring agent used with the master batch. The coloring agent may be a pigment.

The wax is further utilized in the toner particles in addition to the wax used in the master batch.

The wax includes any one selected from a group consisting of a polyolefin-based wax and its derivatives, a hydrocarbon-based wax, a carnauba wax, a rice ester wax and a synthetic ester-based wax.

In accordance with another aspect of the present invention, a method of preparing a toner composition includes preparing a master batch having a coloring agent and a wax in a predetermined ratio; adding to a binder, the master batch, a charge control agent, and at least one component selected from the group consisting of a hydrophobic silica, a hydrophobic titanium oxide and a hydrophobic alumina, to prepare a mixture; and dissolving, kneading and pulverizing the mixture to prepare toner particles.

The method may further comprise adding a hydrophobic silica externally after preparing the toner particles.

The hydrophobic silica constituting the toner particles may be the same type as the hydrophobic silica externally added.

The mixture may be prepared by adding a small quantity of the same coloring agent as the coloring agent contained in the master batch.

The mixture may be prepared by adding a small quantity of a same wax as the wax contained in the master batch.

Additional aspects and/or advantages of the invention will be set forth in part in the description which follows and, in part, will be apparent from the description, or may be learned by practice of the invention.

### BRIEF DESCRIPTION OF THE DRAWING

These and/or other aspects and advantages of the invention will become apparent and more readily appreciated from the following description of the embodiments, taken in conjunction with the accompanying drawing of which:

The FIGURE is a flow chart illustrating operations in accordance with an embodiment of the method of the present invention.

### DETAILED DESCRIPTION OF THE PREFERRED EMBODIMENTS

Reference will now be made in detail to the embodiments of the present invention, an example of which is illustrated in the accompanying drawing. The embodiments are described below to explain the present invention by referring to the figure.

The toner composition according to an embodiment of the present invention includes a coloring agent, a charge control agent, a binder, a wax and an internal additive.

The coloring agent is a material embodying a color of a toner particle, and includes a dyestuff-based coloring agent and a pigment-based coloring agent. Any coloring agent, which is generally and widely used may be used in the coloring agent according to embodiments of the present invention. Preferably, the pigment-based coloring agent, which is very effective in terms of heat stability and light resistance, may be used.

The pigment-based coloring agent, which may be used in the toner composition according to an embodiment of the present invention, includes an azo-based pigment, a phthalocyanin-based pigment, a basic dye-based pigment, a quinacridone-based pigment, a dioxazine-based pigment, condensation azo-based pigment, a chromate, a ferrocyanide, an oxide, a sulfate selenide, a sulfate, a silicate, a carbonate, a phosphate, a metal powder, and a carbon black, or the like. Of these pigments, a single pigment may be used or more than two pigments may be used in combination. However, the pigment-based coloring agent is not limited to these examples.

The coloring agents, which may be used, are as follows, according to colors.

A blue and/or green pigment includes phthalocyanin-based pigments, for example, a copper phthalocyanin, a nonmetal phthalocyanin such as P.B. (pigment blue) 15, 15:1, 15:2, 15:3, 15:4, 15:6, 16, and a phthalocyanin having aluminum, nickel or vanadium as a central metal, and a bridged phalocyanin dimer/oligomer such as an Si-bridged phthalocyanin.

An orange pigment includes a P.O. (pigment orange) 5, 13, 43, 71, 72, or the like.

A yellow pigment includes a P.Y. (pigment yellow) 12, 13, 17, 74, 83, 93, 146, 155, 180, 185, or the like.

A red pigment includes a P.R. (pigment red) 48, 57:1, 122, 146, 147, 176, 184, 186, 202, 207, 238, 254, 255, 269, 270, 272, or the like.

A mixed pigment includes a P.V. (pigment violet) 19/P.R. 122 or P.R. 146/147, or the like.

The quantity of a coloring agent may be within about 1% to about 8% by weight, based on 100% by weight of the total toner particles. When the quantity of the coloring agent is less than about 1% by weight, the optical density on printing into an image is not sufficiently effective. When the quantity of the coloring agent exceeds about 8% by weight, the dispersibility in toner is decreased.

A charge control agent is a material which is added to control charges attached to toner particles. The type of the charge control agent varies depending on whether the charge of the toner particles is positive (+) or negative (−).

The charge control agent employed in embodiments of the present invention is required to be a material that does not react substantially with the functional residue of all binder resin applicable to a toner, such as polyester, and the viscoelastic property of the binder resin is not changed before and after dissolving and kneading. Examples thereof include an azo-based dyestuff, a salicylic acid complex containing an aluminum, a chromium, an iron and zinc, a bis-diphenyl glycolic acid complex containing a boron, a silicate, or the like. However, the charge control agents are not limited to these examples.

A charge control agent containing a heavy metal is not suitable to be used in the present invention since it tends to react with a binder resin.

The quantity of the charge control agent may be about 0.1% to about 6% by weight, based on 100% by weight of the total toner particles. When the quantity of the charge control agent is less than about 0.1% by weight, it is difficult to control the charges of the toner particles. When the quantity of the charge control agent exceeds about 6% by weight, its dispersity is decreased.

The performance of the charge control agent may be enhanced by employing it's a master batch, since the charge control agent has low dispersibility in a binder resin. The term “master batch” herein refers to a mixed solution in “high” concentration in which additives to be included before mixing the total composition are previously mixed in a greater concentration than a predetermined component ratio used in preparing a mixed composition. The master batch in high concentration may be employed by diluting it to obtain a desired quantity when used in an actual mixed composition. By employing this, each component may be correctly weighed and the dispersing performance may be improved. The method is often used to enhance the dispersibility of a pigment when processing a film, petroleum and a number of other plastics, since the particle dispersion force of the master batch is very effective.

The method of making the charge control agent into a master batch includes combining about 80% to about 98% by weight of an ordinary resin and about 20% to about 50% by weight of a charge control agent so that the total weight may be 100% by weight, heating the mixture to above a melting point of the resin, and then dispersing the mixture by applying a shear force. Further, a wax master batch, which is prepared by adhering the particulates of the charge control agent sufficiently dispersed in a solvent to the particulate surface of a wax emulsified in water or an organic solvent, filtering and drying, may be employed.

The binder resin that may be used in the present invention includes, but is not limited to, a homopolymer of a styrene and its derivatives, such as a polyester, a polystyrene, a polyvinyltoluene; a styrene copolymer such as a styrene-acrylic copolymer; and a polyethylene, a polypropylene, a vinyl chloride-based resin, a polyacrylate, a polymethacrylate, a polyacrylonitrile, a melamine resin, an epoxy resin, or the like. Of these resins, a single resin may be used, or more than two resins may be used in mixtures.

Generally, the quantity of the binder resin contained in a toner composition is about 80% to about 98% by weight, based on 100% by weight of the total toner particles.

A wax is one of the representative materials used as a releasing agent. The wax that may be employed in the toner composition according to embodiments of the present invention includes a wax that is effective in preventing offset at an elevated temperature and/or a reduced temperature when fusing a toner, and that exhibits durability. The above-mentioned wax includes a natural wax and a synthetic wax. The natural wax includes a plant wax, such as a carnauba wax and a bay-berry wax; an animal wax, such as a bees wax, a shellac wax and a spermacetti wax; a mineral wax, such as a montanic wax, an ozokerite wax and a ceresin wax; and a petroleum wax, such as a paraffin wax and a microcrystalline wax. The synthetic wax includes a polyethylene wax, a polypropylene wax, an acrylate wax, a fatty acid wax, a silicon wax and a polytetrafluoroethylene wax. The above-mentioned waxes may be used alone, or in mixtures of two or more waxes. However, the wax that may be used in the present invention is not limited to these examples.

Particularly, a polyolefin-based wax and its derivative, a hydrocarbon-based wax, a carnauba wax, a rice ester wax and a synthetic ester-based wax may be used.

When the quantity of the wax is within about 0.5% to about 10% by weight based on 100% by weight of the total toner particles, the effect such as the prevention of offset and improvement in durability is substantial.

The toner particles include at least one component selected from a hydrophobic silica, a hydrophobic titanium oxide and/or a hydrophobic alumina as an internal additive. Such an internal additive helps uniform pulverizing of the toner particles, enhances the durability of the pulverized particles, and prevents generation of excessive fine powders.

Hydrophobic silica may generally be used as the internal additive.

The quantity of such an internal additive may be within about 0.05% to about 3% by weight, based on 100% by weight of the total toner particles.

One of the characteristics of the embodiments of the present invention is that the coloring agent and the wax to be included in the toner particles are included in the form of a master batch. Generally, although a master batch means any solution where components to be mixed are dispersed in a concentration that is higher than a concentration having a predetermined component ratio used in preparing a mixed composition, the master batch of the coloring agent and the wax according to embodiments of the present invention is prepared by dispersing the coloring agent in a base of wax.

The master batch of the wax and the coloring agent is prepared such that pigment particles are adsorbed on the surface of a wax micronized to about 0.1 to about 5 μm in water or an organic solvent, and the quantity ratio of the coloring agent and the wax is controlled to a range of about 1:9 to about 9:1. In preparing the master batch in these ways, production cost may be reduced since a binder resin is not used. In preparing the master batch by using water, the dispersity may be increased since the coloring agent is dispersed in water. Besides, the method where the coloring agent and the wax are included in a predetermined ratio, and then dispersed by applying a significant shear force, may also be used.

After preparing the master batch of a coloring agent and a wax as described above, the master batch, a charge control agent and an internal additive are added to a binder resin, and mixed to prepare toner particles.

The method of mixing raw materials constituting the toner particles includes mixing sufficiently the raw materials in powders in a predetermined ratio with, for example, a HENSCHEL mixer. In the mixing procedure, at least one component selected from the group consisting of a hydrophobic silica, a hydrophobic titanium oxide and a hydrophobic alumina are mixed in a predetermined ratio. The mixture is kneaded with a continuous heating kneader, such as a twin-screw extruder, an open continuous kneader, a 2 or 3 roller, or the like, or a batch-type heating kneader.

In mixing the raw materials, when the coloring agent or the wax is added by adding a master batch, only a coloring agent or a wax may be further added in small quantities to adjust the coloring agent or the wax in a desired ratio. For this case, the coloring agent or the wax to be added must be in smaller quantities than the quantities added by a master batch. When a coloring agent or a wax is further added in small quantities, the effect according to embodiments of the present invention employing the master batch of the coloring agent and the wax may be maintained.

The average particle diameter of the toner particles in the kneaded product becomes about 200 μm to about 800 μm by first pulverizing after cooling. The average particle diameter of the toner particles may also become about 15 μm to about 20 μm, depending on the performance of the pulverizer. This first pulverized toner is pulverized with an impact-type pulverizer or a machine-type pulverizer, and the prepulverized fine powders are removed with a classifying means, e.g., by sieving, to obtain a toner in which the average particle diameter is about 4 μm to about 10 μm, generally about 4.5 μm to about 9.5 μm.

After classifying, an additive is added externally to the toner particles to prepare the final toner composition. The external additive may include a silica in which the surface is hydrophobically treated with a silane coupling agent or a silicon oil or both, a titanium oxide treated hydrophobically in the same manner, and/or an alumina treated hydrophobically in the same manner. Generally, more than two of those external additives, wherein the average particle diameter of a primary particle, or the surface area around the unit weight calculated according to the BET method is substantially different, are employed in mixtures. The BET method was developed by Bruner, Emmett, and Teller for measuring surface area by using nitrogen adsorption condensation in pores at liquid nitrogen temperature, and may also be used to obtain pore volume and pore size.

The silica employed as an external additive and the silica employed in mixing the raw materials may be the same or different types.

A silica is a material generally used as a desiccant; however, it may be sorted according to the size of the particles since its role may vary depending on the size of the particles. When the primary particle size of a silica is more than about 30 nm, the silica is sorted as a large particle silica, and when the primary particle size of a silica is less than about 30 nm, the silica is sorted as a small particle silica. The “primary particle” herein refers to a unit particle of a compound in which polymerization, binding, or the like, did not occur.

The small particle silica may generally enhance the fluidity of a toner particle, and the large particle silica may impart a charging property to a toner particle.

The toner thus prepared is particularly effective in a developing technique of the non-contacting type in which a substantial gap is between a photoconductor and a developing roller. For the non-contacting developing technique, fogging readily occurs since the toner particles made into excessive fine powders are scattered. However, for the toner composition according to embodiments of the present invention, fogging may be suppressed by suppressing the generation of excessive fine powders of the toner, and thus, the occurrence of image contamination may be prevented.

For the non-contacting developing technique, the gap between a photoconductor and a developing roller is about 50 to about 400 μm, generally about 100 μm to about 300 μm.

As for a developing technique, a 2-component technique in which a carrier and a toner are employed in mixtures, and a contacting technique in which a photoconductor and a developing roller are substantially contacted are known. However, the toner according to embodiments of the present invention is more efficient since the toner durability is significant, and filming may be effectively suppressed by a developing blade, when used in the non-contacting developing technique in which an effective stress is applied to the toner by the developing blade employed to form a toner layer uniformly on a developing roller.

Besides, the toner composition may further comprise various additives for improving functional properties. For example, a UV stabilizer, a mildewcide, a bactericide, a fungicide, an anti-static agent, a gloss modifier, an anti-oxidant, and the like may be added to the toner composition as an internal additive or as an external additive.

The FIGURE is a flow chart illustrating operations in accordance with an embodiment of the method of the present invention. The method of preparing a toner composition for an electrophotographic imaging apparatus includes the operations of: preparing a master batch by combining a coloring agent and a wax in a predetermined ratio 102; adding to a binder, the master batch, a charge control agent, and at least one hydrophobic silica, hydrophobic titanium oxide and/or hydrophobic alumina, to prepare a mixture 104; and dissolving, kneading and pulverizing the mixture to prepare toner particles 106. Where desired, a further operation 108 of adding a hydrophobic silica externally after preparing the toner particles 106 may be utilized. The hydrophobic silica utilized to form the toner particles is typically a same type as the hydrophobic silica externally added. Where desired, a further operation of preparing the mixture by adding a small quantity of a same coloring agent as the coloring agent contained in the master batch may be utilized 110. Generally, the mixture is prepared by adding a small quantity of a same wax as the wax contained in the master batch.

Hereinafter, the example according to an embodiment of the present invention and the comparative examples will be described.

### EXAMPLES

### Example of Invention

Preparation of Toner Particles

First, a master batch containing about 50% by weight of a carnauba wax and about 50% by weight of a pigment was prepared by dispersing in water. Carbon black, P.Y. 74, P.R. 57:1, P.B. 15:3 were used as a pigment.

The master batch was controlled so that the quantity of the pigment was about 3% by weight, and the quantity of the wax was about 3% by weight in the toner.

A polyester in which the acid value is about 10 mg KOH/g and Mw/Mn=about 30 was used as the binder resin.

About 1% by weight of a boron complex of a bis-diphenyl glycolic acid was added as a charge control agent.

About 0.3% by weight of silica in which the surface was hydrophobically treated with a silane coupling agent having about 200 m²/g of the surface area by the BET method was added as the internal additive

The master batch, the polyester, and the boron complex of bis-diphenyl glycolic acid were mixed in a HENSCHEL mixer for about 3 minutes, and then the mixture was dissolved and kneaded with a twin screw extruder to first pulverize to about 30 μm. The first pulverized product was pulverized with a machine-type pulverizer having a high speed-spinning rotator, and classified with a classifier using the KORANDER effect to obtain a 4-color toner having about a 6.2 μm average particle diameter.

Preparation of a Toner Composition

About 1% by weight of a silica in which the surface was hydrophobically treated with a silane coupling agent having about 200 m²/g of the surface area by the BET method, about 1% by weight of a silica in which the surface was hydrophobically treated with a silane coupling agent having about 50 m²/g of the surface area by the BET method, and about 0.5% by weight of a titanium oxide in which the surface was hydrophobically treated in the 4-color toner having about a 6.2 μm average particle diameter prepared as above, were placed in a HENSCHEL mixer and were added externally to obtain a toner composition.

### Comparative Example 1

Preparation of Toner Particles

First, a master batch containing about 60% by weight of a polyester (acid value of about 10 mg KOH/g, Mw/Mn=about 30) and about 40% by weight of a pigment was prepared according to an ordinary kneading method. Carbon black, P.Y. 74, P.R. 57:1, P.B. 15:3 were used as a pigment.

The master batch was controlled so that the quantity of the pigment was about 3% by weight in the toner.

A polyester in which the acid value was the same about 10 mg KOH/g as that of the master batch and Mw/Mn=about 30 was used as the binder resin.

About 1% by weight of a boron complex of a bis-diphenyl glycolic acid was added as a charge control agent.

About 3% by weight of a carnauba wax was added as the wax.

The master batch, the polyester, the boron complex of bis-diphenyl glycolic acid and the carnauba wax were mixed in a HENSCHEL mixer for about 3 minutes, and then the mixture was dissolved and kneaded with a twin screw extruder to first pulverize to about 30 μm. The first pulverized product was pulverized with a machine-type pulverizer having a high speed-spinning rotator, and classified with a classifier using the KORANDER effect to obtain a 4-color toner having about a 6.2 μm average particle diameter.

Preparation of a Toner Composition

About 1% by weight of a silica in which surface was hydrophobically treated with a silane coupling agent having about 200 m²/g of the surface area by the BET method, about 1% by weight of a silica in which the surface was hydrophobically treated with a silane coupling agent having about 50 m²/g of the surface area by the BET method, and about 0.5% by weight of a titanium oxide in which the surface was hydrophobically treated, in the 4-color toner having about a 6.2 μm average particle diameter prepared as above, were placed in a HENSCHEL mixer, and were added externally to obtain a toner composition.

### Comparative Example 2

Preparation of Toner Particles

First, a master batch containing about 50% by weight of a carnauba wax and about 50% by weight of a pigment was prepared by dispersing in water. Carbon black, P.Y. 74, P.R. 57:1, P.B. 15:3 were used as a pigment.

The master batch was controlled so that the quantity of the pigment was about 3% by weight, and the quantity of the wax was about 3% by weight in the toner.

A polyester in which the acid value was about 10 mg KOH/g and Mw/Mn=about 30 was used as the binder resin.

About 1% by weight of a boron complex of a bis-diphenyl glycolic acid was added as a charge control agent.

The master batch, the polyester, and the boron complex of bis-diphenyl glycolic acid were mixed in a HENSCHEL mixer for about 3 minutes, and then the mixture was dissolved and kneaded with twin screw extruder to first pulverize to about 30 μm. The first pulverized product was pulverized with a machine-type pulverizer having a high speed-spinning rotator, and classified with a classifier using the KORANDER effect to obtain a 4-color toner having about a 6.2 μm average particle diameter

Preparation of a Toner Composition

About 1% by weight of a silica in which the surface was hydrophobically treated with a silane coupling agent having about 200 m²/g of the surface area by the BET method, about 1% by weight of a silica in which the surface was hydrophobically treated with a silane coupling agent having about 50 m²/g of the surface area by the BET method, and about 0.5% by weight of a titanium oxide in which the surface was hydrophobically treated, in the 4-color toner having about a 6.2 μm average particle diameter prepared as above, were placed in a HENSCHEL mixer, and were added externally to obtain a toner composition.

Test and Results

Test of Particle Size Distribution and its Results

The particle size distribution of the toner before adding externally the external additives of the toner composition according to the Example, the Comparative Example 1 and the Comparative Example 2 were measured with an aperture having about 100 μm of the diameter by a COULTER multisizer type 2. After pulverizing with a machine-type pulverizer, yellow, cyan, magenta and black in the pulverized product were measured.

For the particle size distribution according to the Example, the fine powders below about 3 μm included yellow, cyan, magenta and black in the ratio of about 24%, about 23%, about 27% and about 22%, respectively, based on their numbers, and the yield after classifying was about 82%, on the average, of the four colors.

For the particle size distribution according to the Comparative Example 1, the fine powders below about 3 μm included yellow, cyan, magenta and black in the ratio of about 39%, about 42%, about 41% and about 45%, respectively, based on their numbers, and the yield after classifying was about 67%, on the average, of the four colors.

For the particle size distribution according to the Comparative Example 2, the fine powders below about 3 μm included yellow, cyan, magenta and black in the ratio of about 36%, about 40%, about 39% and about 40%, respectively, based on their numbers, and the yield after classifying was about 71%, on the average, of the four colors.

From the particle size distribution, it can be seen that for the toner composition by the Example according to an embodiment of the present invention, the quantity of the fine powders below about 3 μm was less than that of the Comparative Example 1 and the Comparative Example 2, and the yield after classifying is even higher. Accordingly, it can be seen that for the toner composition according to an embodiment of the present invention, the generation of excessive fine powders was suppressed, the yield on the average of four colors after classifying was significant, and thus, the clarity of the final image would be increased. Further, it can be seen that the toner composition (Comparative Example 2) containing a coloring agent and a wax as a master batch, even though not containing a silica or a titanium oxide as an internal additive, had the effect of suppressing the generation of the excessive fine powders, compared to the toner composition (Comparative Example 1) containing a wax or a pigment, respectively.

Clarity Test of an Image and its Result

The toner compositions according to the Example, the Comparative Example 1 and the Comparative Example 2 were loaded on a full color printer having non-contacting type developing mode to print out images.

In this test, the toner composition of the Example (which employs a coloring agent and a wax according to an embodiment of the present invention and contains an internal additive) could print out more than 5,000 copies of an image with significant quality, while the toner composition according to the Comparative Example 1 incurred image defects at about 2,000 copies, and the toner composition according to the Comparative Example 2 incurred image defects at about 3,500 copies. Accordingly, it can be seen that the toner composition according to an embodiment of the present invention maintains significant quality images to some degree stably even after many times of printing. In the meantime, it may be seen that the toner composition prepared from making a coloring agent and a wax into a master batch, although it does not contain a silica or a titanium oxide, eor the like, as an internal additive, has the stability of high quality images even after many times of printing, since the Comparative Example 2 shows better results than those of the Comparative Example 1.

According to the embodiments of the present invention described above, in a toner composition prepared by pulverizing method, the process of preparing it may be simplified, the cost of preparing it may be reduced, the generation of excessive fine powders may be suppressed, and the durability may be improved to maintain a significant improvement in the quality images even on printing many copies, by employing a master batch of a coloring agent and a wax, and utilizing a silica as an internal additive.

The foregoing embodiments and advantages are merely exemplary and are not to be construed as limiting the present invention. The present teaching can be readily applied to other types of toner compositions and methods of preparing the same. Also, the description of the embodiments of the present invention is intended to be illustrative, and not to limit the scope of the claims. Many alternatives, modifications, and variations will be apparent to those skilled in the art.

What is claimed is:

1. A toner composition of an electrophotographic imaging apparatus, comprising a coloring agent, a charge control agent, a binder, a wax and an internal additive, wherein the coloring agent and the wax are combined to form a master batch, and the internal additive consists includes toner particles having at least one component selected from the group consisting of a hydrophobic silica, a hydrophobic titanium oxide and a hydrophobic alumina.

2. The toner composition as claimed in claim 1, wherein
a quantity of the coloring agent is about 1% to about 8% by weight, based on 100% by weight of the total toner particles;
a quantity of the charge control agent is about 0.1% to about 6% by weight, based on 100% by weight of the total toner particles;
a quantity of the binder is about 80% to about 98% by weight, based on 100% by weight of the total toner particles;
a quantity of the wax is about 0.5% to about 10% by weight, based on 100% by weight of the total toner particles; and
a quantity of the at least one component is about 0.05% to about 3% by weight, based on 100% by weight of the total toner particles.

3. The toner composition as claimed in claim 1, wherein the master batch is prepared with a ratio of the coloring agent to the wax of about 1:9 to about 9:1.

4. The toner composition as claimed in claim 1, further comprising an external additive.

5. The toner composition as claimed in claim 4, wherein the external additive comprises a hydrophobic silica.

6. The toner composition as claimed in claim 5, wherein the hydrophobic silica utilized as the internal additive is a same type as the hydrophobic silica utilized as the external additive.

7. The toner composition as claimed in claim 1, wherein a coloring agent is further added to the toner particles in addition to the coloring agent utilized in the master batch.

8. The toner composition as claimed in claim 1, wherein a wax is further added to the toner particles in addition to the wax utilized in the master batch.

9. The toner composition as claimed in claim 1, wherein the coloring agent is a pigment.

10. The toner composition as claimed in claim 1, wherein the wax is any one selected from the group consisting of a polyolefin-based wax and its derivatives, a hydrocarbon-based wax, a carnauba wax, a rice ester wax and a synthetic ester-based wax.

11. A method of preparing a toner composition for an electrophotographic imaging apparatus comprising:
preparing a master batch by combining a coloring agent and a wax in a predetermined ratio;
adding to a binder, the master batch, a charge control agent, and an internal additive of toner particles having at least one component selected from the group consisting of a hydrophobic silica, a hydrophobic titanium oxide and a hydrophobic alumina, to prepare a mixture; and
dissolving, kneading and pulverizing the mixture to prepare toner particles.

12. The method as claimed in claim 11, further comprising adding a hydrophobic silica as an external additive after preparing the toner particles.

13. The method as claimed in claim 12, wherein the hydrophobic silica utilized as the internal additive is a same type as the hydrophobic silica utilized as the external additive.

14. The method as claimed in claim 11, wherein the mixture is prepared by adding a small quantity of a same coloring agent as the coloring agent in the master batch.

15. The method as claimed in claim 11, wherein the mixture is prepared by adding a small quantity of a same wax as the wax in the master batch.

16. The toner composition as claimed in claim 1, wherein the binder resin is selected from the group consisting of a homopolymer of a styrene and its derivatives including a polyester, a polystyrene, a polyvinyltoluene; a styrene copolymer including a styrene-acrylic copolymer; and a polyethylene, a polypropylene, a vinyl chloride-based resin, a polyacrylate, a polymethacrylate, a polyacrylonitrile, a melamine resin, and an epoxy resin, alone or in combination.

17. The toner composition as claimed in claim 1, wherein the wax is selected from the group consisting of a polyolefin-based wax and its derivative, a hydrocarbon-based wax, a carnauba wax, a rice ester wax and a synthetic ester-based wax.

18. The toner composition as claimed in claim 9, wherein, in the master batch of the wax and the coloring agent, the pigment particles are adsorbed on a surface of a wax micronized to about 0.1 to about 5 μm in water or an organic solvent.

19. The method as claimed in claim 11, further including, after pulverizing, removing fine powders from the toner particles and choosing an average particle diameter to be about 4 μm to about 10 μm.

20. The method as claimed in claim 11, further including adding at least one external additive selected from the group consisting of a silica and a titanium oxide, each of which has a surface hydrophobically treated with a silane coupling agent or a silicon oil or both.
